(19) United States
(12) Patent Application Publication
(10) Pub. No.: US 2010/0250588 A1
(43) Pub. Date: Sep. 30, 2010

(54) IMAGE SEARCHING SYSTEM AND IMAGE SEARCHING METHOD

(75) Inventor: Kazunori KITA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/748,591

(22) Filed: Mar. 29, 2010

(30) Foreign Application Priority Data
Mar. 30, 2009 (JP) 2009-082799

(51) Int. Cl. G06F 17/30

(52) U.S. Cl. 707/769; 707/E17.014; 707/E17.019

(57) ABSTRACT

In an image searching system, a camera 100 stores plural pieces of image data including an object image, each data associated with a shooting orientation and feature information, and has a controller 42 for selecting specific image data from the plural pieces of image data and searching for similar image data based on the feature information associated with the selected data, and a communication unit 36 for sending a search engine server 300 the shooting orientation and feature information of one of the selected image data and similar image data. The search engine server 300 reconstructs a three-dimensional shape of the object image included in the image data based on the feature information and shooting orientation sent from the communication unit, and searches for through information disclosing networks based on the reconstructed shape, obtaining image data including the object image having a shooting orientation different from the sent shooting orientation.

### FIELD OF THE INVENTION

The present invention relates to an image searching system and image searching method and more particularly, to an image searching system and image searching method for searching for images of an objects or scenery seen from desired viewpoints.

### BACKGROUND OF THE INVENTION

As disclosed in Japanese Patent Publication No. 2006-309722 A, a photograph searching/browsing system using a three-dimensional modeling technique is known. Using the photograph searching/browsing system, a user can display or browse digital photographs of a three-dimensional model that the user is now browsing on a screen, shot from close or parallel viewpoints and further the user can display and operate a three-dimensional model from close or parallel viewpoints of photographs that the user is now browsing on the screen.

When the user wants an image seen from his or her desired viewpoint, the photograph searching/browsing system requires to prepare a three-dimensional shape data of the image to use as a search key. But the three-dimensional shape data has drawbacks that increase data amount and lack versatility.

### SUMMARY OF THE INVENTION

The present invention has been made in consideration of the drawbacks of the conventional technique, and the aspect of the invention is to provide an image searching system and an image searching method, which use less number of object images to search for image data including an object image shot from a different shooting direction.

According to one aspect of the invention, there is provided an image searching system, which comprising a communication apparatus and a searching apparatus provided outside the communication apparatus, wherein the communication apparatus comprises storing unit configured to store plural pieces of image data, the image data each including an object image and being associated with a shooting orientation and feature information, selecting/detecting unit configured to select specific image data from the plural pieces of image data stored in the storing unit, first searching unit configured to search for image data similar to the image data selected by the selecting/detecting unit, based on the feature information associated with the selected image data, first sending unit configured to send the searching apparatus the shooting orientation and the feature information of at least one of the image data selected by the selecting/detecting unit and the similar image data located by the first searching unit, and the searching apparatus comprises receiving unit configured to receive the shooting orientation and the feature information sent from the first sending unit of the communication apparatus reconstructing unit configured to reconstruct a three-dimensional shape of the object image included in the image data, based on the shooting orientation and the feature information received by the receiving unit second searching unit configured to search through an information disclosing network based on the three-dimensional shape of the object image reconstructed by the reconstructing unit to obtain image data of an image including the object image having a shooting orientation different from the shooting orientation received by the receiving unit, and second sending unit configured to send the communication apparatus the image data obtained by the second searching unit.

According to another aspect of the invention, there is provided an image searching method, which comprises a detecting step of detecting specific image data from a memory, which stores plural pieces of image data, the image data each including an object image and being associated with a shooting orientation and feature information, a first searching step of searching for image data similar to the detected image data, based on the feature information associated with the detected image data, a reconstructing step of reconstructing a three-dimensional shape of the object image included in the image data, based on the shooting orientation and the feature information of at least one of the image data detected at the detecting step and the similar image data located at the first searching step, and a second searching step of searching through an information disclosing network based on the reconstructed three-dimensional shape of the object image to obtain image data of an image including the object image having a shooting orientation different from the shooting orientation stored in the memory, and an obtaining step of obtaining image data of the object image as the searching result at the second searching step.

### BRIEF DESCRIPTION OF THE DRAWINGS

FIG. 1 is a view showing an embodiment of an image searching system 10 according to the present invention.

FIG. 2 is a block diagram showing a configuration of a camera 100 included in the image searching system 10.

FIG. 3 is a view showing a functional configuration of a search engine server 300 included in the image searching system 10.

FIG. 4 is a block diagram showing a hardware configuration of the search engine server 300.

FIG. 5 is a view showing an example of an image data management table used for managing image data previously recorded in the camera 100.

FIG. 6 is a flow chart showing operations of the camera 100.

FIG. 7 is a flow chart of image searching processes jointly performed by the camera 100 and the search engine server 300.

FIG. 8 is a flow chart showing a three-dimensional shape reconstructing process performed by the search engine server 300.

FIG. 9 is a view showing an example of the invention, in which plural images seen from different viewpoints are used as input images, and a three-dimensional shape model is constructed from these input images, and further two-dimensional images are produced from the three-dimensional shape model, and these two-dimensional images are used as search keys for an image search.

FIG. 10 is a view showing another example of the invention, in which a two-dimensional shape model is constructed form whole images and partial images of substantially the same house.

### PREFERRED EMBODIMENTS OF THE INVENTION

Now, embodiments of an image searching system of the present invention will be described in detail with reference to the accompanying drawings. The composition elements in the embodiments can be replaced with conventional elements as needed. Modifications and variations including a combination with other conventional element may be made to the composition elements disclosed in the present embodiments.

The description of the embodiments of the present invention has been presented for purposes of illustration and description, but is not intended to restrict or limit the invention in the form disclosed herein. The terms “shooting” and/or “pick-up image” used in the description mean an operation of producing image data using digital cameras and/or scanners, wherein the image data can be read by computers.

### [Image Searching System]

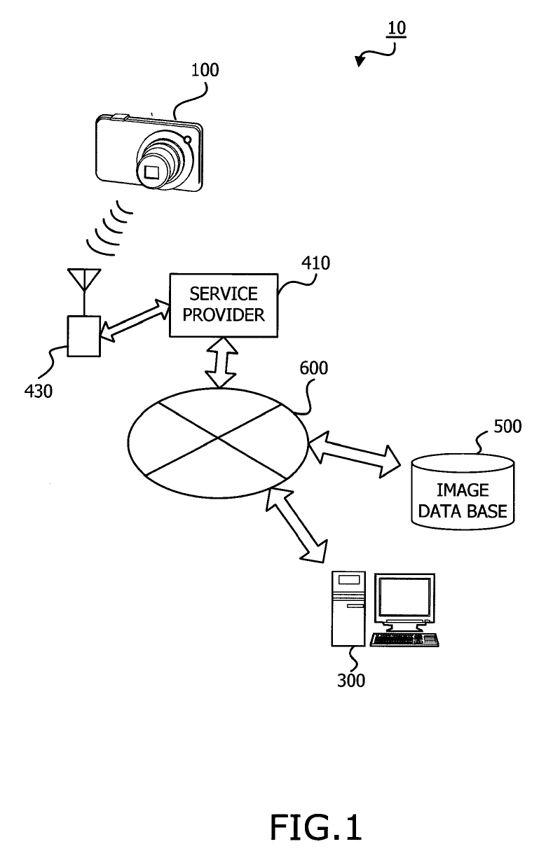

FIG. 1 is a view illustrating an example of an embodiment of an image searching system 10 according to the present invention. As shown in FIG. 1, the image searching system 10 comprises a camera 100, search engine server 300, service provider 410, radio relay station 430, image-data base 500, and a network 600. The Internet such as a wide area network and a local area network (LAN) can be used as the network 600.

A typical digital camera provided with a radio communication function can be used as the camera 100. But the camera 100 is not limited to the typical digital camera, and cellular phones provided with an image pick-up function can be used as the camera 100, too. The camera 100 is connected to the service provider 410 via the radio relay station 430, and is allowed to use network resources connected to the network 600, such as the search engine server 300. The camera 100 has composition elements such as storing unit, selection detecting unit, and transmitting unit, as will be described later.

The radio communication function of the camera 100 is built in as a circuit of the camera 100, or provided by unit of a peripheral device such as a radio communication card. The camera 100 constructed described above can take and encode digital photographs, and then transmits the encoded photographs to a computer. For example, the camera 100 can take and transmit digital photographs to the search engine server 300 through the radio relay station 430, service provider 410 and the network 600. Further, the camera 100 can receive information including digital photographs through an information communication network including a radio communication system. In other words, the camera 100 sends the search engine server 300 a request for an image search. When the search engine server 300 sends back the search result in response to the request, the camera can receive the search result.

The search engine server 300 is connected to terminal devices including the camera 100 through the network 600. Receiving the request for an image search from the terminal device, the search engine server 300 conducts a search under searching conditions and sends a result of the search to the terminal device. Image data to be searched for includes, for example, image data such as the image data base 500 stored in a data base apparatus. The search engine server 300 of the present invention not only searches for images, but also construct a three-dimensional shape model in accordance with the request for an image search and further produces two-dimensional image data from the three-dimensional shape model, conducting the image search using the two-dimensional image data as a search key. In other words, unlike general data base apparatuses such as the mage data base 500, the present search engine server 300 operates to construct the three-dimensional shape model and two-dimensional image data. The search engine server 300 comprises receiving unit, reconstructing unit, searching unit, and sending unit, which will be described in detail later.

The image data base 500 searches for image data under a predetermined searching condition. General data base apparatuses can be used as the image data base 500. Using a predetermined data structure to be described later, the image data base 500 of the present invention can store image data, a shooting orientation of the image data, and featuring information of the image data, wherein the shooting orientation and feature information are associated with the image data.

The service provider 410 is a business entity or an Internet service provider, which provides users with service for connecting to the Internet. The radio relay station 430 is used to provide the camera 100 with the Internet connecting service of the service provider 410. The radio relay station 430 can be integrated into the circuit equipment of the service provider 410.

In the embodiment of the image searching system 10, the camera 100 with the radio communication function sends the search engine server 300 the request for an image search, and the search engine server 300 retrieves a specific image meeting the searching condition from the image data base 500 in response to the request sent from the camera 100 and sends back the result of the image search to the camera 100. In this way, the camera 100 with the radio communication function can receive the result of the retrieval or result of the image search from the search engine server 300.

### [Hardware Configuration of Camera]

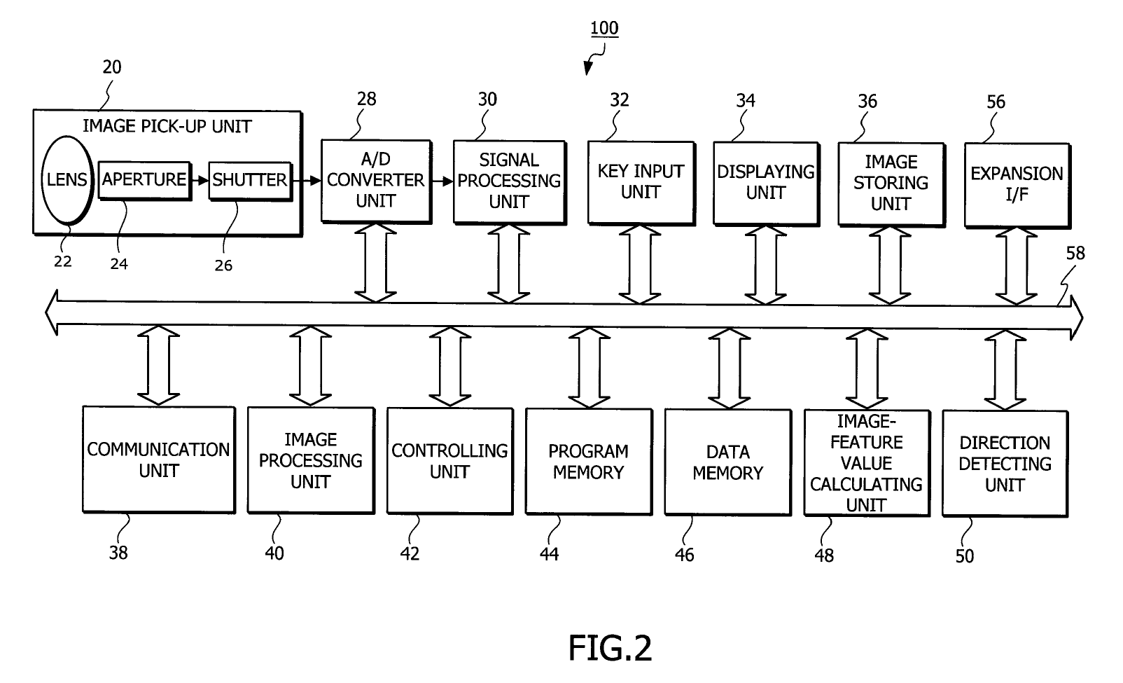

FIG. 2 is a block diagram showing an example of a hard configuration of the camera 100. As shown in FIG. 2, the camera 100 comprises an image pick-up unit 20, A/D converter unit 28, signal processing unit 30, key input unit 32, displaying unit 34, image storing unit 36, expansion I/F 56, communication unit 38, image processing unit 40, controlling unit 42, program memory 44, data memory 46, image-feature value calculating unit 48, and direction detecting unit 50. These units are connected with each other through a bus 58.

The image pick-up unit 20 comprises a lens 22, aperture mechanism 24, and a shutter mechanism 26. The mage pick-up unit 20 operates to form an optical image of an object thereon. A/D converter unit 28 is integrated into an image pick-up device to receive the optical image, generating a digital signal of the optical image. The signal processing unit 30 performs an image interpolating process on the digital signal.

The key input unit 32 is provided with a shutter key, operation key, power key, and mode switching key. The shutter key serves to give an instruction to operate the shutter mechanism 26. The operation key serves to input an instruction to select an image. The power key is operated to turn on or turn off the power of the camera. The mode switching key serves to switch an operation mode from a shooting mode to a reproducing mode, and vice versa.

The displaying unit 34 is used to display in the shooting mode an image of an object that has reached to A/D converter unit 28 from the image pick-up unit 20, and to display in the reproducing mode image data, from which image data stored in the image storing unit 36 and selected is thinned out, operation information, or information relating to image data.

The image storing unit 36 is used to store image data including image data generated by the camera 100. For example, image data received from the search engine sever 300 may be stored in the image storing unit 36.

The communication unit 38 has a built in antenna. The communication unit 38 is used by the camera 100 to make wireless connection with the search engine server 300 of the image searching system 10 through the radio relay station 430. The image data such as the digital photographs generated by the camera 100 can be sent to the search engine server 300 through the communication unit 38. The camera 100 can send the search engine server 300 the request for an image search through the communication unit 38, and can receive the result of the image search from the search engine server 300 through the communication unit 38.

The image processing unit 40 performs operations described below.

[Operation-1 by the image processing unit 40] A process of thinning image data that has been shot or generated in a cyclic manner and supplying the thinned image data to the displaying unit 34 in the shooting mode:
[Operation-2 by the image processing unit 40] A process of compressing/encoding the image data that has been subjected to A/D conversion process and signal process at the time when operation of the shutter key of the key input unit 32 is detected: and
[Operation-3 by the image processing unit 40] A process of supplying the image data stored in the image storing unit 36 to displaying unit 34 in response to detection of a predetermined operation on the key input unit 32 in the reproducing mode.

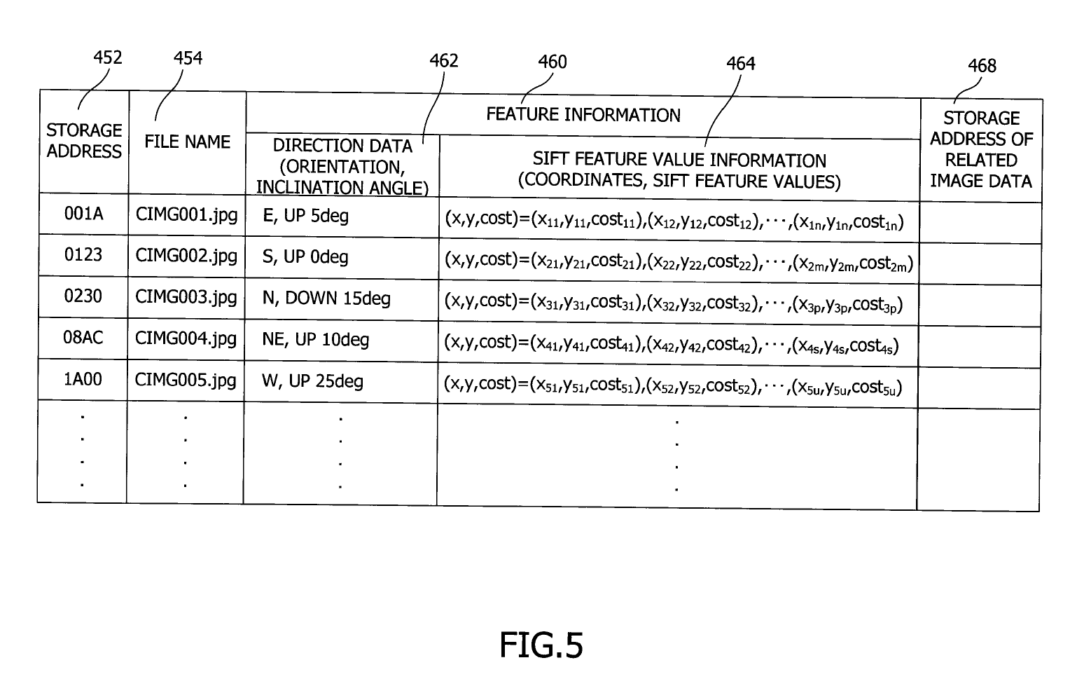

The controlling unit 42 operates as described below.

[Operation-1 by the controlling unit 42] An operation is to control the whole operation of the camera 100:

[Operation-2 by the controlling unit 42] An operation is to store image data and sets of an orientation, an inclination angle, coordinates and SIFT feature values in a management table, wherein the image data is previously recorded in the image storing unit 36, data memory 46 and/or a memory card, and the orientation, inclination angle, coordinates and SIFT feature values are detected by the direction detecting unit 50. The management table will be described in detail with reference to FIG. 5 later. The memory card is connected to the camera 100 through the expansion I/F 56.

[Operation-3 by the controlling unit 42] An operation is to compare SIFT feature values of plural pieces of image data stored in the image storing unit 36, adding a tingle of the coordinates, thereby calculating degrees of similarity of the image data:

[Operation-4 by the controlling unit 42] An operation is to send the image search server 300 sets of an orientation, an inclination angle, coordinates, and SIFT feature values, which are associated with plural pieces of image data, wherein the plural pieces of image data are determined based on the degrees of the similarity to be similar to each other: and

[Operation-5 by the controlling unit 42] An operation is to display on the displaying unit 34 the result of the image search received from the search engine server 300: The “plural pieces of image data determined to be similar” in the operation-4 by the controlling unit 42 can include “plural piece of image data which are determined to be identical or the same”.

The program memory 44 stores a control program to be executed by the controlling unit 42.

The data memory 46 is used as a work memory for temporarily storing numerals which are used by the controlling unit 42 during its operation. The data memory 46 is also used for storing image data.

The image-feature value calculating unit 48 performs an operation of calculating SIFT feature values of each coordinate and listing a predetermined top number of sets at a time of recording images.

SIFT (Scale Invariant Feature Transform) feature values are feature values that determine a representing luminance gradient direction of a pixel and form a luminance gradient histogram based on the gradient direction and are described using a multidimensional vector (for example, refer to “Object Recognition using SIFT feature based on Area Segmentation” by Nagahashi, Fujiyoshi and Kanade, The Institute of Electrical Engineers of Japan, System/Control Research Group. pp 39-44, January, 2007: Literature is available at <URL: http://www.vision.cs chubu.ac.jp/04/pdf/PIA08/pdf>) For example, plural outstanding points (featuring points or prominent points) are detected from an image and feature values are extracted using pixel values in the peripheries of the outstanding points.

In calculating SIFT feature values, a target image is divided into area segmentations for detecting featuring points. In dividing the target image into area segmentations, contaminated normal distributions are used (Refer to Study by Nagahashi, et al, 2007). Then, in calculating SIFT feature values, the representing luminance gradient direction of a target pixel is determined. For example, when a luminance gradient direction of an image L (x, y) is expressed by θ (x, y) and a magnitude of the luminance gradient is expressed by m (x, y), the luminance gradient direction θ (x, y) and the magnitude m (x, y) of the luminance gradient can be calculated by the following formulas, respectively.

$$m ( x , y ) = \sqrt{{f}_{x} ( x , y ) + {f}_{y} ( x , y )}$$

$$θ ( x , y ) = {tan}^{- 1} ( \frac{{f}_{y} ( x , y )}{{f}_{x} ( x , y )} )$$

In the above formulas,

fₓ(x,y)=L(x+1,y)−L(x−1,y)

f_{y}(x,y)=L(x,y+1)−L(x,y−1)

Using the luminance gradient direction θ (x, y) and the magnitude m (x, y) of the luminance gradient, a histogram w (x, y) can be obtained by the following formulas.

$$w ( x , y ) = G ( x , y , σ ) \cdot m ( x , y )$$

$${h}_{θ} = {\sum }_{x} {\sum }_{y} w ( x , y ) \cdot δ [ θ , θ ( x , y ) ]$$

In the above formulas, G (x, y, σ) is Gaussian distribution, and the whole direction which is divided by 36 is used as “θ”. The direction of the maximum magnitude of the histogram can be used as the representing luminance gradient direction at coordinates (x, y) in the target image.

Then, luminance gradient histograms of peripheries are formed on the basis of the representing luminance gradient direction. For example, an area obtained from a normal distribution is divided into 4×4 pixel areas, and luminance gradient histograms of 8 directions are formed in each pixel area. When histograms of 8 directions in each of 4×4 pixel areas are formed, feature values of 128-th dimension vector are obtained. The feature values of 128-th dimension vector obtained as described above are SIFT feature values of a pixel area.

Therefore, SIFT feature values include information which associates coordinates (x, y) in image data with the direction “θ”. Information of the direction “θ” can include angle information such as an orientation angle. For example, the information of direction “θ” can include a value of cosine θ.

In general, the direction detecting unit 50 is provided with an orientation sensor and an inclination angle sensor. The direction detecting unit 50 detects the orientation of an object seen from the camera 100 and an inclination angle of the camera 100, when an instruction of a recording operation has been given in the shooting mode.

The expansion I/F 56 is used to mount a detachable memory card onto the camera 100. Hardware to be connected to the expansion I/F is not limited to the recording medium. For example, the camera 100 can be connected with radio communication unit such as a radio communication card through the expansion I/F in place with the communication unit 38 having the built in antenna, thereby communicating with the image search server 300.

The bus 58 is used to exchange data and control information between the above units.

The hardware configuration shown in FIG. 2 can be used for the camera 100. The image pick-up unit 20 functions as shooting unit, the direction detecting unit 50 functions as orientation detecting unit, the image storing unit 36 and/or data memory 46 function as storing unit, the image-feature value calculating unit 48 functions as feature information obtaining unit for obtaining feature values of image data, the communication unit 38 functions as sending unit for sending feature information and shooting direction, and the controlling unit 42 functions as selection detecting unit, searching unit for searching for image data stored in the storing unit and storage controlling unit.

### [Functions of Search Engine Server]

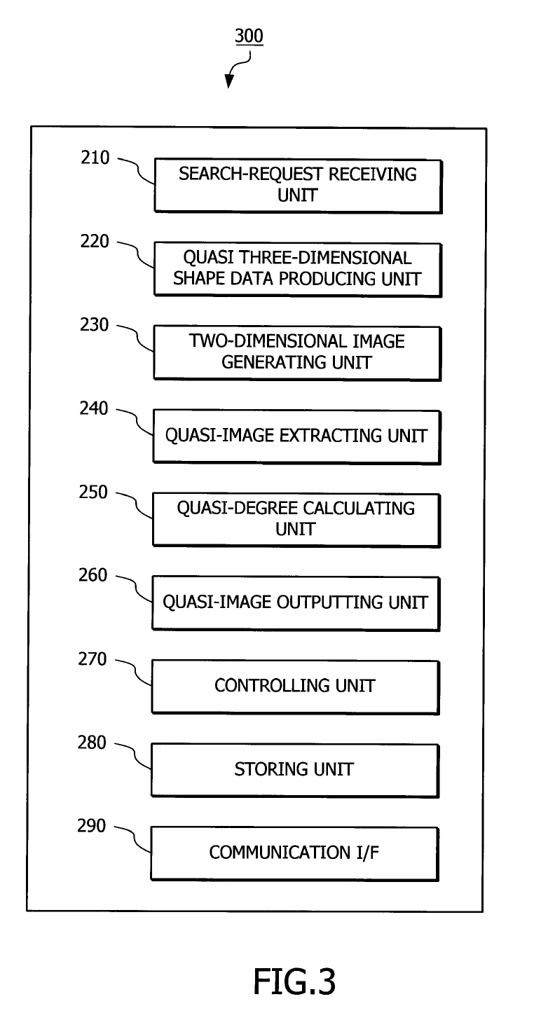

FIG. 3 is a view showing an example of functional configuration of the search engine server 300 in the embodiment of the invention. The search engine server 300 comprises search-request receiving unit 210, quasi three-dimensional shape data producing unit 220, two-dimensional image generating unit 230, quasi-image extracting unit 240, quasi-degree calculating unit 250, quasi-image outputting unit 260, controlling unit 270, storing unit 280, and communication I/F (Interface) 290.

The search-request receiving unit 210 is used by the search engine server 300 to receive search requests. The search request includes at least two input images for producing an image to be used as search keys, and a set of shooting direction and feature information, which set is associated with the input images. For example, as the input images is used image data including digital photographs taken with the camera 100 shown in FIG. 1.

The quasi three-dimensional shape data producing unit 220 produces three-dimensional image data from at least two input images, using a predetermined three-dimensional modeling technique. The three-dimensional modeling technique will be described in detail later.

The two-dimensional image generating unit 230 produces a projection view and/or a cross-section view of the produced three-dimensional image data seen from a shooting direction different from the shooting direction associated with the input images. These projection view and cross-section view can be two-dimensional image data. Production of the projection view and cross-section view will be described in detail later.

The quasi-image extracting unit 240 extracts an image using the produced two-dimensional image data as the search key from a data base such as the image data base 500, connected to a public information network. The quasi-degree calculating unit 250 calculates a quasi-degree between the produced two-dimensional image data and the extracted image.

The quasi-image outputting unit 260 associates the extracted image with the quasi-degree of the extracted image to the produced two-dimensional image data, and outputs the extracted image and the associated quasi-degree to the produced two-dimensional image data as the search result.

The controlling unit 270 controls operations of the above respective unit.

The storing unit 280 is used as temporal recording unit in operation of the above respective unit and/or as recording unit for recording a program for the controlling unit 270.

The communication I/F 290 is used to receive the search request from the camera 100 and to send the search request to the search-request receiving unit 210, and further is used to receive the search result from the quasi-image outputting unit 260 and to send the search result to the camera 100.

The functional configuration shown in FIG. 3 can be used as the search engine server 300 and/or search engine server functions. In other words, the search-request receiving unit 210 can function as the receiving unit for receiving the feature information and the shooting direction from the camera 100, the controlling unit 270 can function as reconstructing unit for reconstructing a three-dimensional shape of an object image and searching unit for searching for images through the information, disclosing network, and the communication I/F 290 can function as the sending unit for sending the searched images to the camera 100.

### [Hardware Configuration of Search Engine Server]

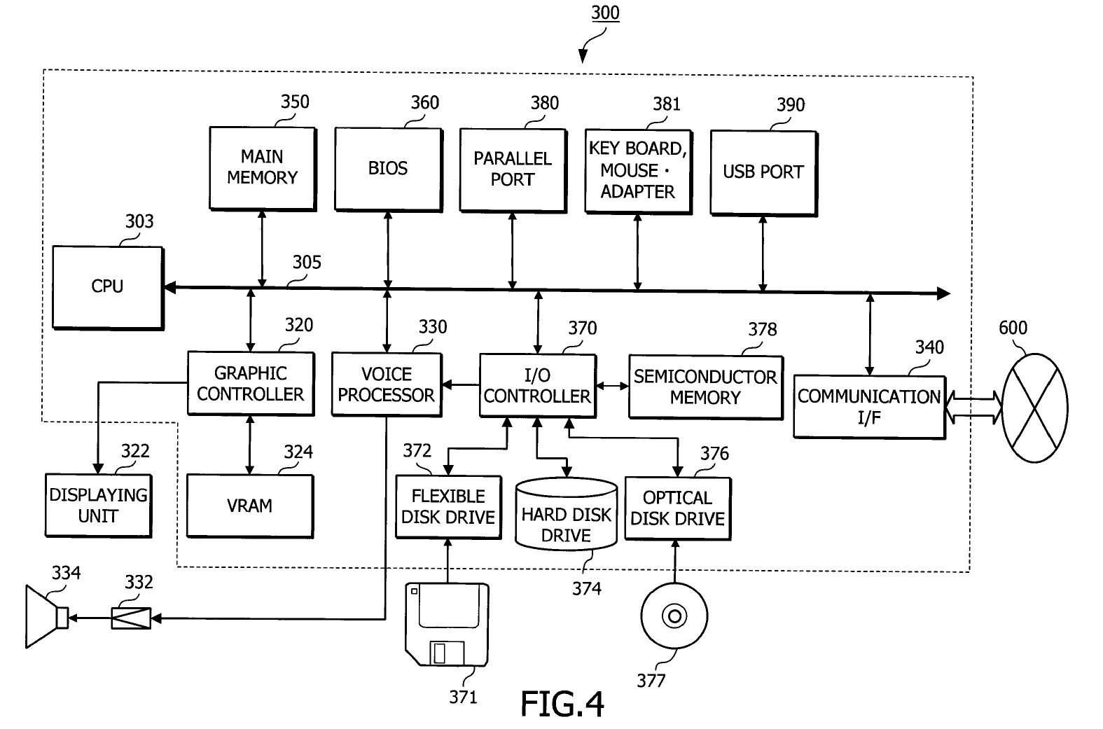

FIG. 4 is a view showing an example of a hardware configuration of the search engine server 300. A general hardware configuration of the search engine server 300 is described with reference to a computer working as a typical information processing apparatus shown in FIG. 4. The search engine server 300 can be constructed with essential elements needed under the circumstances.

The search engine server 300 has a function of a computer. The search engine server 300 comprises CPU (Central Processing Unit) 303, a bus line 305, communication I/F 340, main memory 350, BIOS (Basic Input Output System) 360, parallel port 380, USB port 390, graphic controller 320, VRAM 324, voice processor 330, I/O controller 370, and an input devices 381, such as a key board and a mouse. Recording devices such as a flexible disk (FD) drive 372, hard disk drive 374, optical disk drive 376 and a semiconductor memory 378 can be connected to I/O controller 370.

The communication I/F 340 is used to connect the search engine server 300 to the network 600. In other words, the search engine server 300 can be connected with the camera 100 included in the image search system 10 shown in FIG. 1 to communicate with the camera 100, whereby the search engine server 300 is allowed to receive as input images image data such as digital photographs taken with the camera 100 and/or image data stored in the PC 490 and/or in the image data base 500.

The voice processor 330 is connected with a microphone 336, amplifier 332 and speaker 334. The graphic controller 320 is connected with a displaying apparatus.

BIOS 360 stores a boot program which CPU 303 executes to boot the search engine server 300, and a program depending on the hardware of the search engine server 300.

FD (flexible disk) drive 372 reads a program and data from the flexible disk 371, and supplies the program and data to the main memory 350 and/or hard disk 374 through I/O controller 370.

An example of the search engine server 300 with the built-in hard disk 374 is shown in FIG. 3, but it is possible to use an external hard disk in place of the built in hard disk or in addition to the built-in hard disk. The external hard disk is connected to the search engine server 300 through an interface (not shown) for connecting external apparatuses, wherein the interface is connected to the bus line 305 and/or I/O controller 370.

For example, DVD-ROM drive, CD-ROM drive, DVD-RAM drive, and BD (Blue-Ray Disk)-ROM drive can be used as the optical disk drive 376. In these cases, it is necessary to use optical disks 377 that are compatible with these drives, respectively. The optical disk drive 376 reads the program or data from the optical disk 377, and supplies the program or data the main memory 350 or hard disk 374 through I/O controller 370.

The computer program supplied to the disk 371 is stored on recoding media such as the flexible disks 371, optical disks 377 or memory cards, and the recording media are supplied to users. The computer program is read from the recording medium through I/O controller 370, or is downloaded through the communication I/F 340 to be installed and run by the search engine server 300. The operation to be executed by the information processing apparatus running the computer program is the same as the operation executed by the apparatus previously described, and therefore, the further description thereof will be omitted.

The computer program can be stored in an external recording medium. In addition to the flexible disks 371, optical disks 377 and memory cards, tape media and magnet-optical media such as MD can be used as the external recording medium. It is possible to use recording devices such as a hard disk and/or optical disk drive connected to a special communication circuit or the Internet as the recording medium for storing the computer program, and to supply the computer program to the search engine server 300 through the communication circuit or the Internet.

In the above embodiment, mostly the search engine server 300 has been described, but a computer can realize substantially the same function as the information processing apparatus described above, wherein a program having the function described in the information processing apparatus is installed in the computer.

The hardware configuration shown in FIG. 4 can be used as the configuration of the search engine server 300. In other words, the communication I/F 340 can function as the receiving unit for receiving feature information and shooting direction from the camera 100 and as the sending unit for sending the camera 100 an image obtained from the search result, and CPU 303 can function as the reconstructing unit for reconstructing a three-dimensional shape of an object image and as the searching unit for searching for images through the information disclosing network.

The search engine server 300 can be realized by hardware, software, and/or combining hardware and software. In the combination of the hardware and software, the search engine server 300 can be realized by a typical computer system with a predetermined program installed therein. In this case, the predetermined program is loaded in the computer system, thereby making the computer system execute processes relating to the invention. The program consists of an instruction represented in arbitrary languages, codes, or notations. The instruction group is used to make the computer system directly execute specific functions, or to make the computer system execute the specific functions after either (1) transforming to other language, codes, or notation or (2) duplicating to other medium, or after (1) and (2). As a matter of course, such program itself and a program product including recording media recording the program fall within the scope of the present invention. The program for realizing the functions of the invention can be recorded on computer readable recording media such as the flexible disk, MO, CD-ROM, DVD, hard disk device, ROM, MRAM and RAM. The program can be downloaded from other computer system connected to the communication circuit to store in the computer readable recording media, or can be duplicated from other media. Further, the program can be compressed and/or divided to be stored in a single or plural recording media.

[Data Structure which can be Managed by Search Engine Server]

FIG. 5 is a view showing an example of an image data management table used for managing image data in the present embodiment. The image data management table shown in FIG. 5 has a data structure including fields of storage addresses 452, file names 454, feature information 460, and storage addresses 468 of related image data. The feature information 460 includes direction data 462 and SIFT feature value information 464. In the present embodiment, the image data management table is stored in the image storing unit 36 of the camera 100 shown in FIG. 2. But the image data management table can be stored in any recording media, if the media are proper for managing image data. For example, the image data management table can be stored in the hard disk 374 of the search engine server 300 shown in FIG. 4.

The storage addresses 452 are memory addresses used to store the image data in the image storing unit 36. Even when the image data is stored in the data memory or memory card connected through the expansion I/F 56, the storage addresses are assigned to respective pieces of image data to be recorded in the management table.

The file names 454 are file names given to the respective pieces of image data. For instance, every time an object is shot and a new piece of image data is produced, it is possible for the controlling unit 42 to designate a file name of the image data.

The direction data 462 comprises an orientation and an inclination angle detected at a time of image recording. The information (orientation and inclination angle) is detected by the direction detecting unit 50 every time image data is produced when an object is shot with the camera 100. Therefore, every piece of direction data 462 is associated with one file name of image data.

SIFT feature value information 464 comprises coordinates indicating positions where SIFT feature values exist and SIFT feature values. One piece of image data is analyzed by the image-feature value calculating unit 48 and SIFT feature vales and coordinates indicating positions where such SIFT feature values exist (coordinates of feature points) are calculated. That is, SIFT feature value information 464 including sets of coordinates and SIFT feature values is obtained. For instance, SIFT feature value information 464 consists of coordinates (x, y) and values of cosine of representing luminance gradient directions. One piece of image data contains plural pieces of SIFT feature value information 464.

As shown in FIG. 5, one piece of image data having the storage address 452 of “001A” and file name 454 of “CIMG001.jpg” has SIFT feature value information 464 which includes “n” pieces of information such as (x11, y11, cos t11), (x12, y12, cos t12), . . . , (x1n, y1n, cos t1n). Image data having other storage address 452 or file name 454 has a similar data structure. Each piece of image data has plural pieces of SIFT feature value information 464 independently from each other.

The storage addresses 468 of related image data is used to associate the image data with other image which is found similar to the image data in the similar image search according to the present invention.

The data structure of the image data management table shown in FIG. 5 can be used to store the image data not only in the camera 100 but also in the hardware (for example, in the hard disk 374) of the search engine server 300 shown in FIG. 4. Therefore, the image search server 300 can associate image data having a specific file name with the feature information of the image data and can store them using the data structure of the image data management table.

### [Image Search Operation]

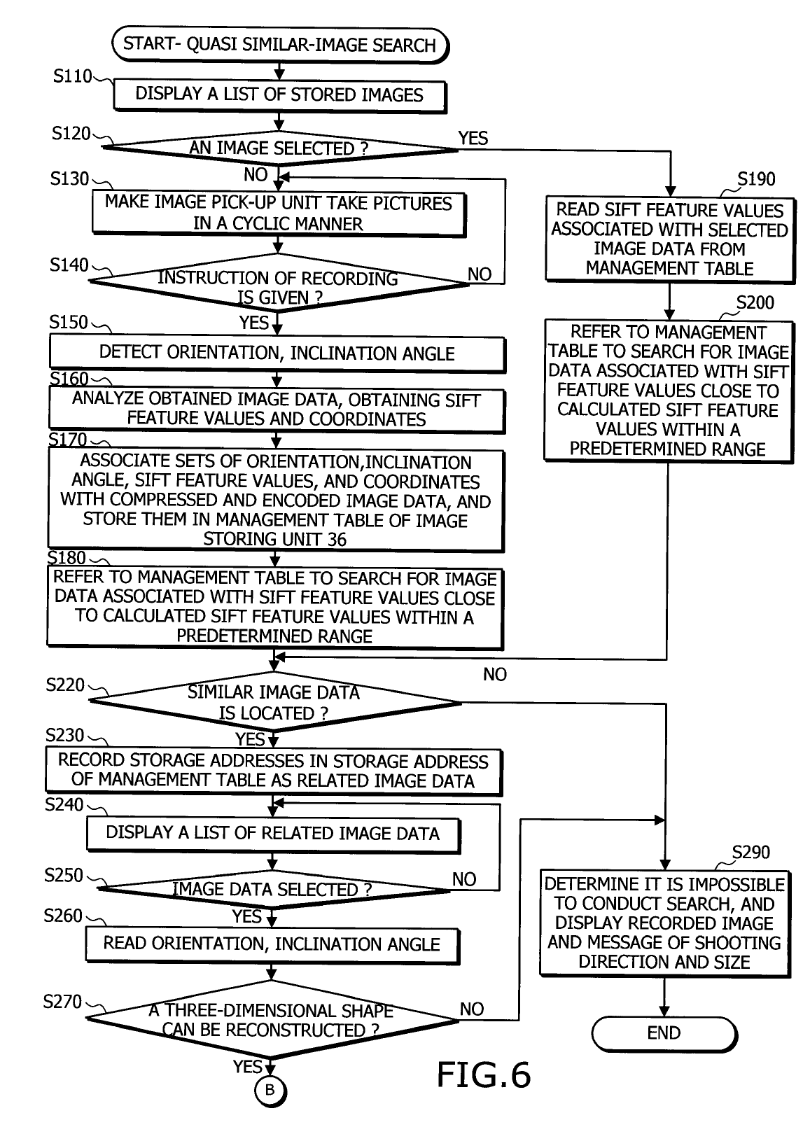

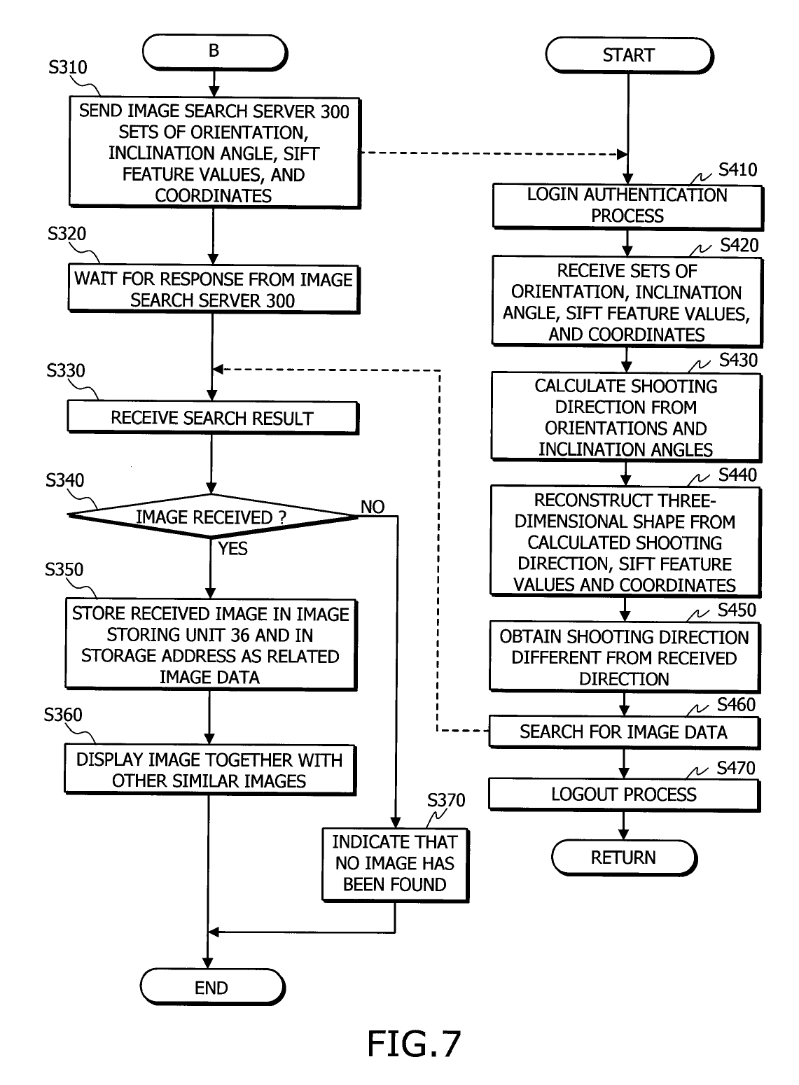

FIGS. 6 and 7 are flow charts of an image search operation performed by the image searching system 10 of the present invention. FIG. 6 is a flow chart showing steps of the image search operation performed by the camera 100. FIG. 7 is a flow chart showing steps of the image search operation jointly performed by the camera 100 and search engine server 300. The camera 100 operates under control of the controlling unit 42, and meanwhile the search engine server 300 operates under control of CPU 303.

In the similar image search conducted in the present embodiment, two-dimensional image data is produced from the three-dimensional shape model to search for similar images. It is possible to treat similar images as comparison of values by comparing feature values each representing the feature of each image in compact. In the operation of the image searching system 10 of the invention, SIFT feature values of each image are calculated at steps S110 to S200 in FIG. 6.

The operation of the camera 100 will be described with reference to the flow chart of FIG. 6. The camera 100 displays a list of the images stored therein on the displaying unit 34 at step S110.

The camera 100 judges at step S120 whether or not an image has been selected from the list of the images displayed on the displaying unit 34. When it is determined at step S120 that the judgment is true (YES at step S120), that is, when an image has been selected from the list of the images, then the camera 100 advances to step S190. When it is determined at step S120 that the judgment is not true (NO at step S120), that is, when an image has not been selected from the list of the images, then the camera 100 advances to step S130. More specifically, the controlling unit 42 detects operation performed on the key input unit 32, thereby determining whether or not an image has been selected.

The camera 100 makes the image pick-up unit 20 take pictures in a cyclic manner at step S130. For instance, a user takes digital photographs with the camera 100.

The camera 100 judges at step S140 whether or not an instruction of a recording operation has been given. When it is determined at step S140 that the judgment is true (YES at step S140), that is, when an instruction of a recording operation has been given, then the camera 100 advances to step S150. When it is determined at step S140 that the judgment is not true (NO at step S140), that is, when an instruction of a recording operation has not been given, then the camera 100 returns to step S130. For instance, when a digital photograph has been taken and new image data is compressed, encoded, and stored in the image storing unit 36, then it is determined that the judgment is true.

The camera 100 detects an orientation and an inclination angle at step S150. For example, the camera reads a shooting direction and inclination angle detected by the direction detecting unit 50.

The camera 100 analyzes the image data which has been shot and obtains SIFT feature values and coordinates at step S160, whereby SIFT feature values and coordinates of the image data are calculated and stored as SIFT feature value information.

The camera 100 associates an obtained set of an orientation, an inclination angle, SIFT feature values and coordinates with the compressed and encoded image data, and writes them in the management table of the image storing unit 36 at step S170. The management table uses, for instance, the data structure of the image data management table shown in FIG. 5. The image data which the management table can refer to can be stored in the image storing unit 36, data memory 46, and/or a memory card (not shown) which is connected to the camera 100 through the expansion I/F 56.

The camera 100 refers to the management table to search for image data associated with SIFT feature values close to the calculated SIFT feature values within a predetermined area at step S180, whereby other image data having feature values similar to the newly shot image data is located within the camera 100.

Meanwhile, the camera 100 reads SIFT feature values associated with the selected image data from the management table at step S190. This operation unit that the image data already shot and stored in the camera 100 is selected and the features values of the selected image data are referred to. Therefore, even if a new photograph is not taken, the camera 100 uses the image data already obtained to search for a similar image.

The camera 100 refers to the management table to search for image data associated with the read SIFT feature values and close SIFT feature values within a predetermined area at step S200. This operation corresponds to the operation performed at step S180 when the new image data is shot.

The camera 100 judges at step S220 whether or not a similar image data has been found. When it is determined at step S220 that similar image data has been found (YES at step S220), the camera 100 advances to step S230. When it is determined at step S220 that similar image data has not been found (NO at step S220), the camera 100 advances to step S290.

The camera 100 stores storage addresses of the similar image data in the storage address of the management table as related image data at step S230. In other words, plural pieces of image data having SIFT feature values falling within a predetermined area are similar to each other and treated as related image data.

The camera 100 displays a list of the related image data on the displaying unit 34 at step S240. Then, the camera 100 judges at step S250 whether or not any related image data has been selected from the displayed list of the related image data. When it is determined at step S250 that related image data has been selected from the list of the related image data (YES at step S250), the camera 100 advances to step S260. When it is determined at step S250 that related image data has not been selected from the list of the related image data (NO at step S250), the camera 100 returns to step S240.

The camera reads an orientation and inclination angle of each piece of the selected related image data from the management table at step S260. The camera judges at step 270 whether or not it is possible to reconstruct a three-dimensional shape by using the read orientations and inclination angles. When it is determined at step S270 that it is possible to reconstruct a three-dimensional shape (YES at step S270), the camera 100 advances to step S310 in FIG. 7. When it is determined at step S270 that it is not possible to reconstruct a three-dimensional shape (NO at step S270), then the camera 100 advances to step S290.

The camera 100 determines at step S290 that it is impossible to search for and displays on the displaying unit 34 the read image (shot and recorded image) and a message expressing a direction in which a shooting operation should be performed and a size (a size of an object to be searched for compared with an field angle). In other words, this operation at step S290 is performed when it is determined at step S220 that the similar image has not been found, or when it is determined at step S270 that it is impossible to reconstruct a three-dimensional shape using the similar image data. The camera 100 terminates the similar image search operation after step S290.

As described above, when the judgment is true at step S270, that is, when it is determined at step S270 that it is possible to reconstruct a three-dimensional shape using the orientations and inclination angles, at least two pieces of similar image data and related sets of an orientation, an inclination angle and SIFT feature values and coordinates are prepared in the camera 100.

An image searching process to be jointly performed by the camera 100 and the image search server 300 will be described in detail with reference to the flow chart of FIG. 7. Operations at steps 310 to 5370 in FIG. 7 are performed by the camera 100 and operations at steps S410 to S470 in FIG. 7 are performed by the search engine server 300.

When the judgment is true at step S270 in FIG. 6, operation at step S310 is performed. The camera 100 sends sets of an orientation, an inclination angle and SIFT feature values and coordinates to the search engine server 300 at step S310. The camera 100 sends the sets of information, as the search request.

The camera 100 keeps ready for communicating with the search engine server 300 and waits for a response to the search request from the image search server 300 at step S320.

Meanwhile, the search engine server 300 performs the similar image searching operation in response to the search request from the camera 100.

The search engine server 300 performs a login authentication process at step S410, whereby a search request of a specific camera 100 is accepted by the search engine server 300, and one process of a similar image searching operation starts.

The search engine server 300 receives as a search key the sets of an orientation, an inclination angle and SIFT feature values and coordinates at step S420. The search engine server 300 calculates a shooting direction from the received orientations and inclination angles at step S430.

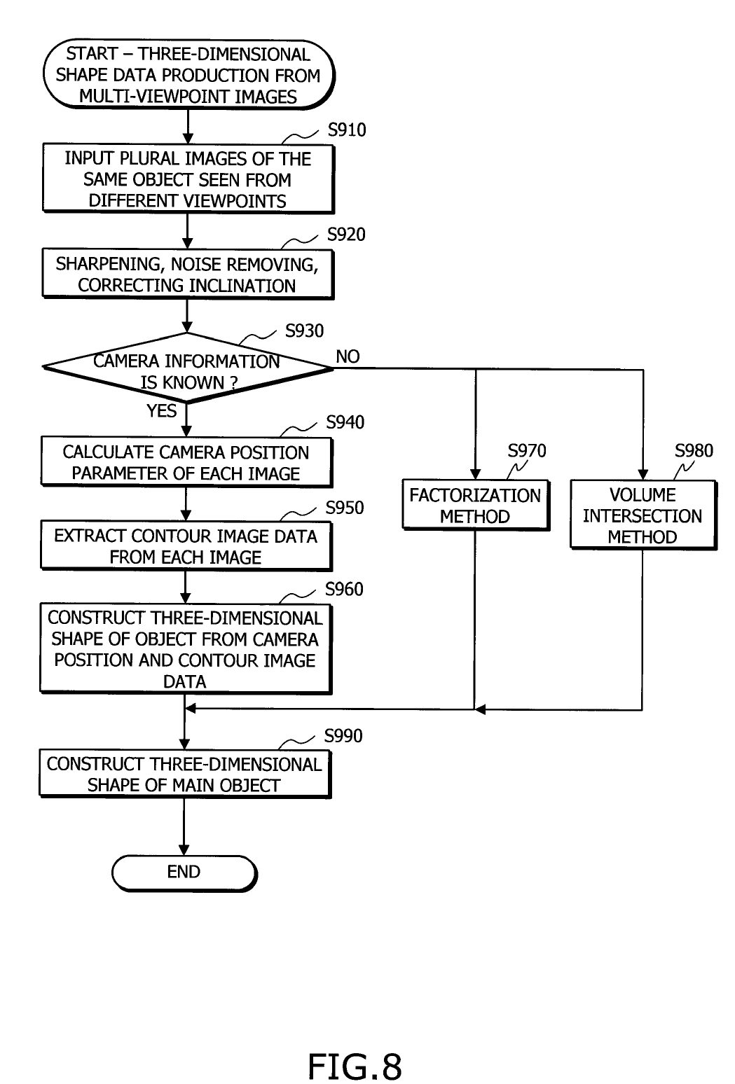

The search engine server 300 performs a process of reconstructing a three-dimensional shape from the calculated shooting direction and SIFT feature values and coordinates at step S440. Then, the three-dimensional modeling operation is performed and three-dimensional image data is produced based on the search request. At step S440, a process whose flow chart is shown in FIG. 8 can be used. The process produces three-dimensional shape data from a multi-viewpoint image, as will be described in detail later.

The search engine server 300 acquires at step S460 from the reconstructed three-dimensional shape a shooting direction which has not been received. In other words, two-dimensional image data such as a projection view and cross-section view seen from the shooting direction, which are not included in the search request, are produced from the produced three-dimensional image data.

The search engine server 300 searches for image data at step S460. In other words, using the two-dimensional image data produced at step S450 as the search key, the search engine server 300 searches for similar images through data base connected to the information disclosing network such as the image data base 500, and sends the search result to the camera 100.

The search engine server 300 performs a logout process at step 470, terminating one process of the similar image searching operation started in response to the search request of the specific camera 100. After terminating the process of the similar image searching operation, the search engine server 300 returns to a standby state for accepting another search request from the terminal apparatus such as the camera 100.

Then, the process returns to the operation of the camera 100, again. The camera 100 receives the search result at step S330.

The camera 100 judges at step S340 whether or not an image has been received as the search result. When it is determined at step S340 that an image has been received (YES at step S340), the camera 100 advances to step S350. When it is determined at step S340 that an image has not been received (NO at step S340), the camera 100 advances to step S370.

The camera stores the received image in the image storing unit 36 at step S350, and adds and stores the received image in the storage address as related image data, whereby the image data received as the search result is stored in the image storing unit 36 as the result of the similar image searching operation. The recording unit for recording mage data is not limited to the image storing unit 36, but the data memory 46 and a memory card which is connected to the camera 100 through the expansion I/F 56 can be used as such recording unit.

The camera 100 displays on the displaying unit 34 the related image data received as the search result together with other similar image at step S360, whereby the user is allowed to review the related image data and other similar image displayed on the displaying unit 34.

Meanwhile, when it is determined at step S340 that an image has not been received (NO at step S340), the camera 100 indicates at step S370 that no image has been found. After step S360 or step S370, the camera 100 terminates the similar image searching operation.

As described above, during the operations at step S110 (FIG. 6) to step S470 (FIG. 7), the camera 100 cooperates with the search engine server 300 to conduct the similar image search using the three-dimensional image data and two-dimensional image data produced by the search engine server 300.

The similar image searching operation is performed once during the operations at step S110 to step S470, but in the case it is determined at step S220 that a similar image data has been found and the camera 100 adds the similar image data, the search engine server 300 can narrow down the search result using such additional image data.

Further, predetermined three-dimensional image data previously prepared can be used as the additional image data. From the predetermined three-dimensional image data prepared previously and quasi three-dimensional shape data can be produced two-dimensional image. Further, the produced two-dimensional image may be compared with a predetermined two-dimensional image prepared previously.

FIG. 8 is a flow chart showing a three-dimensional shape reconstructing process, which is performed at step S440 in FIG. 7 by the search engine server 300 under control of CPU 303. In the processes shown in FIG. 8, the search engine server 300 produces the three-dimensional shape data from the multi-viewpoint image.

The search engine server 300 inputs plural images of the same object seen from different viewpoints at step S910. The search engine server 300 performs a preprocessing (sharpening image, noise removing, correcting inclination of images) at step S920.

The search engine server 300 judges at step S930 whether or not camera information is already known. When it is determined at step S930 that the camera information is already known (YES at step S930), the camera advances to step S940. When it is determined at step S930 that the camera information is not known (NO at step S930), then the camera advances to step S970 or step S980. The camera information unit parameters such as shooting orientations, which are associated with plural pieces of image data, respectively. Whether the search engine server 300 advances to step S970 or step S980 is determined depending on the conditions other than the camera information. That is, whether the search engine server 300 advances to step S970 or step S980 is determined depending on the number of pieces of image data used to produce a three-dimensional shape data, an average of feature values calculated with respect to images or statistical information such as distribution of calculated feature values, an arbitrary numerical number, or design information of the camera used for shooting an object.

The search engine server 300 calculates a camera-position parameter of each image at step S940. For example, a distance between the camera 100 and an object and a shooting orientation are calculated. The search engine server 300 extracts contour image data from each image at step S950, whereby contour image data of each image is produced.

The search engine server 300 produces a three-dimensional shape model of the object from the camera position and contour images at step S960, whereby a three-dimensional shape model is produced, which is obtained when substantially the same object is seen from plural viewpoints.

The search engine server 300 performs a factorization method at step S970. For instance, the factorization method is an image information processing method performed as follows:

(Factorization Method—process 1) extracts line segments, curved segments, or feature points representing an outline of an object and feature portions of a face from each image.

(Factorization Method—process 2) extracts feature points of major points of each image and associates these feature points of images with each other.

(Factorization Method—process 3) reconstructs information of camera movement and information of a three-dimensional shape of an object from point coordinates in a multi-viewpoint image.

The search engine server 300 performs a volume intersection method at step S980. For instance, the volume intersection method is performed as follows:

(Volume intersection method—process 1) prepares a three-dimensional voxel space to memorize a shape and divides the three-dimensional voxel space into grids in three-dimensional space.

(Volume intersection method—process 2) inputs silhouette images of multi-viewpoint images to be processed, and makes back-projection by orthogonal projection onto the divided grids (voxel).

(Volume intersection method—process 3) judges whether or not a silhouette image of an image to be processed is found in each voxel, and removes voxels except the voxels in which silhouette images are found.

(Volume intersection method—process 4) repeats the judgment with respect to all the voxels, and further repeats judgment of voxel with respect to all the multi-viewpoint images.

(Volume intersection method—process 5) produces a three-dimensional shape model of the object from a class of the remaining voxels.

The search engine server 300 produces three-dimensional shape data of the main object at step S990. A format of the three-dimensional shape data to be produced can arbitrarily use a wire frame model, surface model, solid model, CSG (Constructive Solid Geometry), and boundary representation.

After step S990, a production of the three-dimensional shape data from a multi-viewpoint image terminates.

[Embodiment, into which Plural Images Seen from Different Viewpoints are Input]

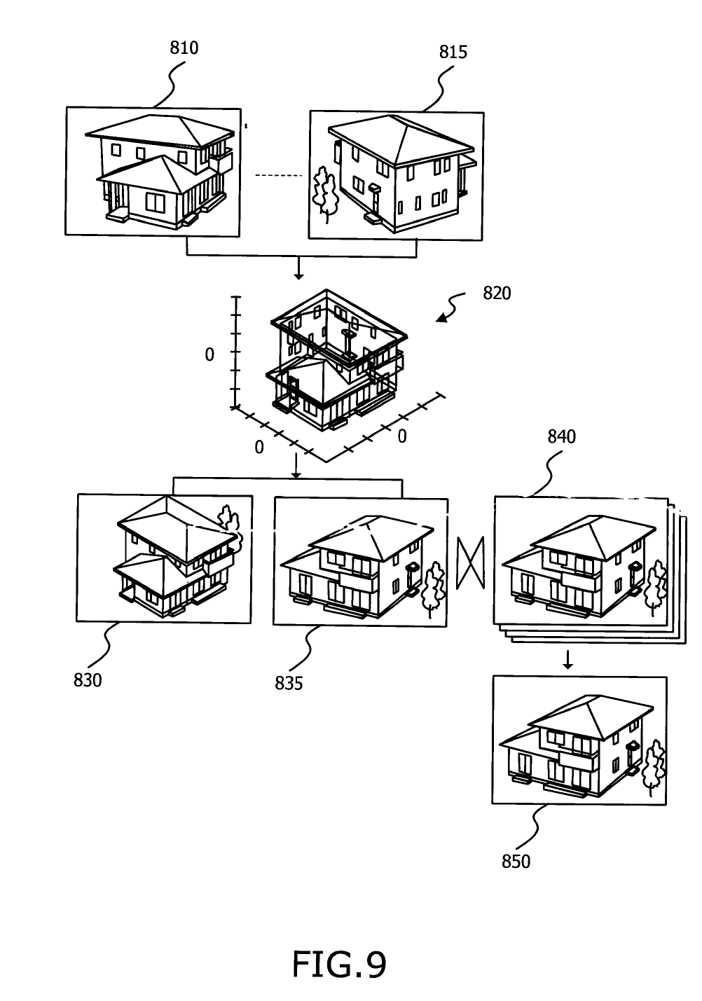

FIG. 9 is a view showing one example of the invention, in which plural images seen from different viewpoints are used as input images, and a three-dimensional shape model is constructed from these input images, and further two-dimensional images are produced from the three-dimensional shape model, and these images are used as search keys for searching images. Hereinafter, operation of the image searching system 10 including the camera 100 and search engine server 300 will be described.

In FIG. 9, an input image “A” 810 and an input image “B” 815 are digital photographs of substantially the same house shot from different viewpoints. The camera 100 stores these images in the image storing unit 36 and can display them on the displaying unit 34 according to need in the shooting mode or in the reproducing mode. The camera 100 sends these images and accompanying information such as SIFT feature values to the search engine server 300, thereby requesting the search for similar images.

The search engine server 300 constructs a three-dimensional shape model 820 from the input images 810, 815. For instance, the three-dimensional shape reconstructing process is performed at step S440 in FIG. 7.

The search engine server 300 produces projection images projected from directions different from the shooting directions of the input images. For instance, projection images are produced of the three-dimensional shape model 820 projected from directions which are not received. For example, two-dimensional image data 830, 835 seen from different viewpoints are produced.

The produced two-dimensional image data 830, 835 are used as search keys for searching for images through the data base such as the image data base 500. For instance, image data 840 recorded in the image data base 500 is compared with the two-dimensional image data 330 or 835 seen from the different viewpoints.

As the result of comparison, when it is determined that the recorded image data 840 is similar to the two-dimensional image data 330 or 835 seen from the different viewpoints, the search engine server 300 sends the camera 100 a similar image 850 found in the recorded image data 840 as the search result.

As described above, the image searching system 10 uses image data of substantially the same object shot from different viewpoints as input images, constructs a three-dimensional shape model 820, produces two-dimensional image data 830, 835 seen from different viewpoints, and searches for similar images using the two-dimensional image data 830, 835.

Although specific embodiments of the present invention have been illustrated in the accompanying drawings and described in the foregoing detailed description, it will be understood that the invention is not limited to the particular embodiments described herein, but numerous rearrangements, modifications, and substitutions can be made without departing from the scope of the invention. In the example shown in FIG. 9, two images shot from different viewpoints are used as input images, but more than two images shot from different view points can be used as the input images, if they can be installed. Further, the whole image and partial images can be used as input images to construct a three-dimensional shape model. The camera 100 records an arbitrary number of whole images or partial images of substantially the same object in the image storing unit 36, and displays them on the displaying unit 34 according to need, and sends the search engine server 300 these images and accompanying information such as SIFT feature values, requesting the image search for similar images. In the same manner as the example shown in FIG. 9, the search engine server 300 constructs a three-dimensional shape model from these whole images or partial images and produces projection images from the three-dimensional shape model.

[Embodiment, in which Whole Images and Partial Images are Used as Input Images]

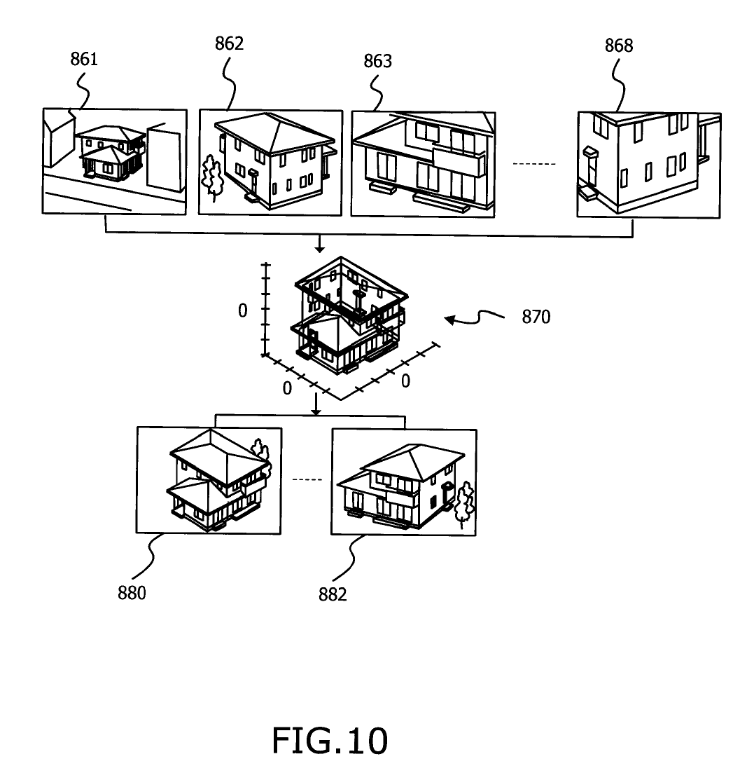

FIG. 10 is a view showing another example, in which a two-dimensional shape model is constructed form whole images and partial images of substantially the same house. Like the input images 810, 815 in FIG. 9, an input image 1 (861), input image 2 (862), input image 3 (863), . . . , and input image N (868) in FIG. 10 are digital photographs of the substantially the same house, which are seen from different viewpoints, respectively. These input images include whole images and partial images of substantially the same house. “N” is an arbitrarily natural number. The camera 100 stores these images in the image storing unit 36 and can display them on the displaying unit 34 according to need in the shooting mode or in the reproducing mode. The camera 100 sends these images and accompanying information such as SIFT feature values to the search engine server 300, thereby requesting the search for similar images.

In the same manner to the example shown in FIG. 9, the search engine server 300 constructs a three-dimensional shape model 870 from these input images 861, 862, . . . , N. Further, the search engine server 300 produces projection images projected from directions different from the shooting directions of the input images. Therefore, projection images projected from directions different from the shooting directions of the input images, for example, two-dimensional image data 880, 882 seen from different viewpoints are produced.

As described above, in the similar image searching operation relating to the present invention, whole images and/or partial image of substantially the same object can be used to construct the three-dimensional shape model.

The embodiments including one camera 100 and radio relay station 430 have been described, but the image searching system can use plural number of cameras including cellar phones with an image pick-up function and further use plural number of radio relay stations. Images can be used for the searching operation, which images the user takes in using a terminal device provided with a scanner for reading images, pointing device and pen tablet for drawing images, or the user draws on a tablet operating the pointing device such as a mouse and/or specific pen. The search engine server 300 can communicate with plural cameras and terminal devices in various ways. For example, wired or wireless connection to the networks through service providers and/or radio relay stations may be used. Not only wide area networks such as the Internet but also local area network (LAN) and their combination may be used as such networks.

The search engine server 300 judges whether or not image data from the camera has been taken at positions falls within a predetermined area or at times falling within a predetermined time range, and determines that images falling within the predetermined area or time range are substantially the same data, and uses such data as input images of the same object, conducting the image search.

Modification may be made such that images of the same object, which are shot from different viewpoints within a predetermined area substantially at the same time with plural radio controlled cameras operated by a terminal device connected to the network, are sent to the search engine server 300, and that the terminal device connected to the network is used to receive the search result from the search engine server 300.

In the embodiments, the search engine server 300 and camera 100 are prepared separately from each other, but a camera having a function of the search engine server can be used. More specifically, it is possible to use a hardware resource of the camera to construct a three-dimensional shape model and further to produce two-dimensional image data from the three-dimensional shape model. In this case, the camera 100 performs the processes, which are performed by the search engine server 300 in FIG. 7. Modification can be made to the embodiments described above, such that the camera having the function of the search engine server 300 constructs the three-dimensional shape model from input images and produces two-dimensional image data from the three-dimensional shape model in the same manner as the search engine server 300, and uses the produced two-dimensional image data as search keys of the similar image searching operation, searching for similar images through the image data base 500.

The image searching system according to the invention can be realized using the camera provided with the function of the search engine server 300. But rearrangement may be made such that a camera that has not all the functions of the search engine server 300 but a part of them is used and that the search engine server 300 constructs the three-dimensional shape model from input images, producing two-dimensional image data from the three-dimensional shape model and performs the similar image searching process, using the produced two-dimensional image data as search keys. The camera has only a part of the functions of the search engine server 300.

77

Further, other terminal device connected to the network can have a part of the functions of the search engine server 300. The function of the search engine server 300 is not performed by a single server apparatus but can be shared by plural terminal devices. In other words, all the processes shown in FIG. 7 are not performed independently by the search engine server 300 but performed jointly by plural terminal devices.

The embodiments of the invention, in which a digital camera is used as the camera 100, have been described, but the present invention can be applied to image pick-up apparatuses having an image-picking up function, such as cellular phones with a camera function, and PDA (Personal Digital Assistant) with a camera function. Further, the image searching system of the present invention can be realized by an image searching computer program, wherein the image searching computer program, when installed on a computer, makes the computer function as the image searching system of the present invention, wherein the computer is mounted on an image pick-up apparatus having CPU and a memory. The image searching computer program can be distributed through communication lines. The image searching computer program can be recorded on CD-ROM and distributed. The program for controlling operation of the search engine server of the invention can be written using languages well known to those skilled in the art. The program can be realized as a virtual machine working on hardware such as cameras and/or terminal devices.

What is claimed is:

1. An image searching system comprising:
a communication apparatus; and
a searching apparatus provided outside the communication apparatus, wherein
the communication apparatus comprises:
storing unit configured to store plural pieces of image data, the image data each including an object image and being associated with a shooting orientation and feature information;
selecting/detecting unit configured to select specific image data from the plural pieces of image data stored in the storing unit;
first searching unit configured to search for image data similar to the image data selected by the selecting/detecting unit, based on the feature information associated with the selected image data;
first sending unit configured to send the searching apparatus the shooting orientation and the feature information of at least one of the image data selected by the selecting/detecting unit and the similar image data located by the first searching unit; and
the searching apparatus comprises:
receiving unit configured to receive the shooting orientation and the feature information sent from the first sending unit of the communication apparatus;
reconstructing unit configured to reconstruct a three-dimensional shape of the object image included in the image data, based on the shooting orientation and the feature information received by the receiving unit;
second searching unit configured to search through an information disclosing network based on the three-dimensional shape of the object image reconstructed by the reconstructing unit to obtain image data of an image including the object image having a shooting orientation different from the shooting orientation received by the receiving unit; and
second sending unit configured to send the communication apparatus the image data obtained by the second searching unit.

2. The image searching system according to claim 1, wherein the communication apparatus further comprises:
image pick-up unit configured to shoot an object to obtain image data;
orientation detecting unit configured to detect a shooting orientation when the image pick-up unit shoots the object;
feature information obtaining unit configured to obtain feature information relating to the image data obtained by the image pick-up unit; and
storage controlling unit configured to associate the image data obtained by the image pick-up unit with the shooting orientation detected by the orientation detecting unit and the feature information obtained by the feature information obtaining unit, and storing the image data associated with the shooting orientation and the feature information in the storing unit.

3. The image searching system according to claim 1, wherein the selecting/detecting unit detects that image data has been selected, which includes at least two digital photographs that are shot at positions and/or times falling within a predetermined range.

4. The image searching system according to claim 1, wherein the second searching unit narrows down image data to be searched for as the number of the specific image data selected by the selecting/detecting unit increases.

5. An image searching method comprising:
a detecting step of detecting specific image data from a memory, which stores plural pieces of image data, the image data each including an object image and being associated with a shooting orientation and feature information;
a first searching step of searching for image data similar to the detected image data, based on the feature information associated with the detected image data;
a reconstructing step of reconstructing a three-dimensional shape of the object image included in the image data, based on the shooting orientation and the feature information of at least one of the image data detected at the detecting step and the similar image data located at the first searching step; and
a second searching step of searching through an information disclosing network based on the reconstructed three-dimensional shape of the object image to obtain image data of an image including the object image having a shooting orientation different from the shooting orientation stored in the memory; and
an obtaining step of obtaining image data of the object image as the searching result at the second searching step.
